(19) United States
(12) Patent Application Publication
(10) Pub. No.: US 2026/0309415 A1
(43) Pub. Date: Oct. 8, 2026

(54) DRYER SYSTEM

(71) Applicant: Scheuch Management Holding GmbH, Aurolzmünster (AT)

(72) Inventor: Thomas LACHER, Frankenburg (AT)

(21) Appl. No.: 19/483,204

(22) PCT Filed: May 10, 2024
(86) PCT No.: PCT/EP2024/062908

§ 371 Date: Nov. 10, 2025

(30) Foreign Application Priority Data
May 12, 2023 (EP) 23172985.6

(51) Int. Cl. F26B 21/20; F26B 17/04; F26B 25/00

(52) U.S. Cl. CPC F26B 21/20; F26B 17/04; F26B 25/007; F26B 2200/02; F26B 2200/24

(57) ABSTRACT

A dryer system comprises a dryer, a gas inlet and gas outlet connected to the dryer, and a gas suction device connected to the gas outlet. The dryer comprises a receiving device between the gas inlet and outlet, designed to receive products to be dried. The gas suction device comprises a gas-particle separator with a fan arranged in a flow path running from the gas inlet via the gas outlet and through the gas-particle separator. In an operating state of the gas suction device, the flow path in the gas-particle separator comprises a first flow path and a second flow path that a smaller mass flow of particles is provided in the first flow path than the second flow path. The gas suction device comprises a first and second output into which the first and second flow paths merge, respectively. The second output is connected to a filter system.

### CROSS REFERENCE TO RELATED APPLICATIONS

The present application is a U.S. National Phase of International Application No. PCT/EP2024/062908 entitled “DRYER SYSTEM”, and filed on May 10, 2024. International Application No. PCT/EP2024/062908 claims priority to European Patent Application No. 23172985.6 filed on May 12, 2023. The entire contents of each of the above-listed applications are hereby incorporated by reference for all purposes.

### TECHNICAL FIELD

The invention relates to a dryer system comprising a dryer for products to be dried, at least one gas inlet connected to the dryer, at least one gas outlet connected to the dryer, wherein the dryer comprises a receiving device between the at least one gas inlet and the at least one gas outlet, the receiving device being designed to receive the products to be dried, and at least one gas suction device connected to the at least one gas outlet for suctioning gas and particles of the products, the particles being entrained with the gas.

### BACKGROUND AND SUMMARY

The invention also relates to a method for drying products, comprising the steps of:
introducing the products in a dryer;
applying a gas flow in the dryer to the products;
discharging the gas brought into contact with the products and particles of the products, the particles being entrained with the gas, out of the dryer with at least one gas suction device.

Dryer systems for drying products, for example agricultural products, by means of an air stream or generally a gas stream and, if appropriate, by heat supply are known. For this purpose, ambient air is guided in known systems in an upper region of the dryer system over heating devices and is thereby heated. The products are applied as uniformly as possible to a drying belt running under the heating devices, for example made of an air-permeable, woven plastic material. The process air heated by means of the heating devices is then sucked downwards through the drying belt and removes moisture from the products on the belt. The moisture-laden exhaust air is released back into the environment. In the known dryer systems, the products to be dried also act as filters. For many products, this filter effect was sufficient in the past to comply with the legal requirements for dust emissions. However, since the type of materials to be dried has changed over time and waste wood is increasingly mixed in, which is relatively dry and has a higher dust content than, for example, chopped material, compliance with the limit values for emissions is becoming increasingly difficult. One option to comply with the emission limits is to filter the exhaust air stream. The disadvantage here is that the filter required for this generally has to filter very large amounts of air, usually up to 350,000m³/h. Known dryer systems whose exhaust air stream is to be filtered therefore lead to high production and operating costs.

Devices for separating particles from air flows without a filter are also known.

GB 187,348 A discloses a fan with a housing and a rotor. A plurality of openings are provided in the housing, which lead into pockets. Due to the rotation of the rotor, which sucks air in the axial direction, particles to be separated from the air are transported to an inner wall of the housing and through the air stream further into the pockets and collected therein.

U.S. Pat. No. 3,796,511 A discloses a fan having a partly circular housing in which a rotor sucks in air and causes it to rotate. Particles entrained with the air are deflected by centrifugal force to the inner side of the housing and exit through a slot in the housing.

U.S. Pat. No. 8,353,665 B1 relates to an impeller for use in a two-chamber contaminant-extracting blower having a first outlet for purified air and a second outlet for dirt and air. The impeller has specially shaped blades. The contaminant-extracting blower has a complex structure.

However, the known devices for separating particles from air flows are not designed to clean an exhaust air stream from a dryer system in compliance with legally defined emission limit values.

The object of the invention is to provide a dryer system and a method for drying products of the type mentioned at the outset, which avoid or at least reduce the disadvantages known from the prior art. The dryer system should only release purified exhaust air into the environment and still be able to be built cost-effectively and operated in an energy-saving manner. The method is intended to enable reliable and cost-effective drying of products with the lowest possible environmental impact due to released dust or generally released particles.

The above objectives are at least partially realized through a dryer system and a method for drying products as described herein.

With regard to the dryer system, the invention provides that at least one of the at least one gas suction device comprises a gas-particle separator with a fan for generating a gas flow, wherein the fan is arranged in a flow path running from the gas inlet via the gas outlet and through the gas-particle separator, wherein, in an operating state of the gas suction device, the flow path in the gas-particle separator comprises a first flow path, in particular main flow path, and a second flow path, in particular secondary flow path, in such a way that a smaller mass flow of the particles is provided in the first flow path than in the second flow path, wherein the gas suction device comprises a first output, in particular a main output, into which the first flow path merges, and a second output, in particular a secondary output, into which the second flow path merges, wherein the second output is connected to a filter system.

The dryer system thus comprises a dryer in which products to be dried can be dried. Examples of the products to be dried are cuttings, biomass or biowaste, in particular wood chips, wood chips, bark, sugar beet chips, lucerne/alfalfa, grass, bagasse, maize, biomass as fuel, pomace, maize seedlings or beer grains. For drying, the products are exposed to a gas stream, which removes moisture from the products. The gas stream preferably has a higher temperature than room temperature or ambient temperature, for which purpose at least one heating device may be arranged upstream of the dryer or in the dryer. In order to guide the gas stream through the dryer, at least one gas inlet connected to the dryer and at least one gas outlet connected to the dryer are provided. The gas stream can be introduced into the dryer via the gas inlet and the gas stream can be discharged from the dryer via the gas outlet. Arranged between the at least one gas inlet and the at least one gas outlet, in particular in the region for the gas stream, is a receiving device which is designed to receive the products to be dried. For example, the receiving device comprises a carrier tape made of an air-permeable material, in particular woven plastic material, on which the products can be placed. During the drying of the products received up by the receiving device, these not only release moisture to the gas stream flowing around the products, but also, with increasing drying, small particles, for example dust particles, small plant residues or the like, are released from the products and carried along with the gas stream. Thus, the gas stream at the gas outlet has a higher humidity and a higher concentration of particles than at the gas inlet. In order to suction the gas and the particles of the products entrained with the gas out of the dryer, at least one gas suction device is connected to the at least one gas outlet. The gas suction device thus suctions the gas and the entrained particles out of the dryer in an operating state. The at least one gas suction device may also be provided to suck the gas stream through the gas inlet into the dryer. If a plurality of gas outlets are provided, each gas outlet is preferably connected to its own gas suction device. However, a plurality of gas outlets may also be connected to a common gas suction device. If, in contrast to the present invention, an attempt were now made to filter all the suctioned-off gas with the particles contained therein with a filter, a comparatively complex filter system would be required because of the high volumetric flow of the gas, for example 350,000m³/h. In addition, the gas suction device would have to be dimensioned with correspondingly high electrical power in order to convey the entire volumetric flow through the filter system, resulting in high operating costs. In contrast, according to the invention, a separation of the suctioned-off gas stream with the particles contained therein into a low-particle gas stream, preferably with a high volumetric flow, and a high-particle gas stream, preferably with a lower volumetric flow, is provided, wherein only the high-particle gas stream with a preferably lower volumetric flow is filtered. For this purpose, it is provided that at least one of the at least one gas suction device comprises a gas-particle separator with a fan for generating a gas flow. The gas-particle separator is designed, as is generally customary, to remove particles from the gas stream. For this purpose, the gas-particle separator comprises the fan for generating a gas flow, which in operation sucks in the gas with the particles. In this case, the fan is arranged in a flow path running from the gas inlet via the gas outlet and through the gas-particle separator. In an operating state of the gas suction device, the flow path in the gas-particle separator comprises a first flow path, in particular a main flow path, and a second flow path, in particular a secondary flow path, in such a way that a smaller mass flow of the particles is provided in the first flow path than in the second flow path. In other words, a smaller mass flow of the particles is conveyed via the first flow path and a larger mass flow of the particles is conveyed via the second flow path. The first flow path may be a main flow path and the second flow path may be a secondary flow path. In this case, a larger volumetric flow of the gas and a smaller mass flow of the particles are provided in the main flow path than in the secondary flow path. Accordingly, a larger volumetric flow of the gas and a smaller mass flow of the particles can be conveyed via the main flow path and a smaller volumetric flow of the gas and a larger mass flow of the particles can be conveyed via the secondary flow path. The gas flow is thus divided in the gas-particle separator into a first flow in the first flow path and a second flow in the second flow path. For discharging the divided gas flow from the gas suction device, the gas suction device comprises a first output, in particular the main output, into which the first flow path, in particular the main flow path, merges, and it comprises a second output, in particular a secondary output, into which the second flow path, in particular the secondary flow path, merges. Since the first flow is less contaminated with particles, it does not have to be filtered. The second output, on the other hand, is connected to a filter system. The filter system is designed to filter the particles contained in the second flow path out of the gas stream, so that a purified gas can be released into the environment, which in particular meets the legal limits for emissions. Since only the second flow, with a smaller volumetric flow of the gas compared to the entire gas flow, is filtered, the filter system can be dimensioned correspondingly small and operated in an energy-saving manner. The volumetric flow of the gas in the first flow path may be greater than, equal to, or less than the volumetric flow of the gas in the second flow path. For example, if the first flow path is a main flow path and the second flow path is a secondary flow path, the ratio of the volumetric flow of the gas in the main flow path to the volumetric flow of the gas in the secondary flow path may be between 90:10 and 70:30, preferably about 80:20. For example, the volumetric flow of the gas in the second flow path, in particular the secondary flow path, may be 30,000 m³/h to 70,000m³/h. The ratio of the mass flow of the particles in the second flow path, in particular if it is a secondary flow path, to the mass flow of the particles in the first flow path, in particular if it is a main flow path, may be, for example, between 90:10 and 70:30, preferably about 80:20. For example, the particle concentration at the gas outlet may be 50 mg/m³, the volumetric flow of the gas at the gas outlet may be 350000 m³/h, the proportion of the particles in the second flow path may be 80% of the total particles, and therefore the mass flow of the particles in the second flow path may be 14 kg/h (with the range examples given above, about 12 kg/h to 16 kg/h). After the filter system, the particle concentration may be 0.1 mg/m³ and the mass flow of the particles can be between 3 and 10 g/h, for example 7 g/h. In the case of a different volumetric flow of the gas at the gas outlet, for example 10,000m³/h, different values naturally result.

If reference is made in this description to location and direction information such as “top”, “bottom”, “front”, “rear” or “side”, this information is to be understood in a state in which the dryer system has been installed ready for operation. The term “vertical” means in the direction of gravity, from “top” to “bottom”, or vice versa.

According to a preferred embodiment of the dryer system, the first output and the second output may be provided in a tubular connecting body connected to a separator output of the gas-particle separator. In this way, it is not necessary to modify an existing, comparatively expensive gas-particle separator to incorporate the first output and/or the second output therein or to retrofit an existing fan to a gas-particle separator having first and second outputs. Instead, the first output and the second output may be realized in the tubular connecting body at the factory or may be subsequently introduced into the connecting body at the place of use. The connecting body may be produced comparatively inexpensively and, in the assembled state of the dryer system, is connected to the gas-particle separator, in particular arranged at the separator output of the gas-particle separator. In order to be able to discharge the second flow as completely as possible through the second output from the gas-particle separator, the second output is preferably arranged as close as possible to the separator output. It is particularly favorable if the distance of the second output from the separator output is less than the largest cross-sectional dimension of the separator output, in particular at most half the largest cross-sectional dimension of the separator output. The tubular connecting body may be designed to be round or polygonal in cross-section, in particular circular, rectangular or square, and have a length that is greater than, equal to or smaller than the largest cross-sectional dimension of the separator output.

For a particularly simple construction, it can be provided that the second output is a through-opening in a circumferential lateral surface of the connecting body. The through-opening may be made in the lateral surface using low-cost tools, such as a drilling device, a cutting tool, or a punching device.

It is particularly favorable if the filter system comprises a particle filter and a filter fan assigned to the particle filter, wherein in particular the particle filter and the filter fan are arranged in a common filter flow path. In this case, the particle filter is designed to retain, i.e. not allow to pass, particles of different sizes which are supplied to the particle filter. In order to enable sufficient gas flow through the particle filter, the filter fan may also be provided, which can be connected upstream or downstream of the particle filter in the direction of flow of the gas flow. In particular, the filter fan generates a suitable pressure of the second flow on the particle filter. The value of the pressure depends on the nature, for example the density and the thickness of the particle filter in the direction of flow. So that the second flow can be completely filtered, the particle filter and the filter fan are arranged in particular in a common filter flow path, i.e. a common flow path in the filter system.

If at least two gas suction devices with gas-particle separators are provided, the same number of filter systems may be provided as gas suction devices with gas-particle separators, and the second output of each of the at least two gas suction devices with gas-particle separators can be connected to a filter system assigned only to this second output. In this way, every second output can be connected to its own filter system, whereby the filter systems can be designed smaller.

However, it may be particularly expedient for the second outputs of at least two gas suction devices with gas-particle separators, in particular of all gas suction devices with gas-particle separators, to be connected to a common filter system. The filter system common to a plurality of second outputs is dimensioned to filter a plurality of second streams together in this case. For example, at least two second outputs may be connected to a common filter system and other second outputs may each be connected to their own filter system.

For a cost-effective design, it may be provided that the particle filter is a bag filter or a cartridge filter. A bag filter is essentially a surface filter generally made of fibrous material, wherein the filter medium is formed into a hose. A cartridge filter is generally in the form of a cylindrical sleeve and filters the second stream by means of the lateral surface of the sleeve. Thus, known particle filters may be used.

It can be particularly advantageous if a first fluid line for returning gas and particles from the first flow path into the gas inlet is provided between the first output of at least one of the gas suction devices and at least one of the at least one gas inlet, and/or a filter fluid line for returning gas and any remaining particles from the second flow path into the gas inlet is provided between a filter output of the filter system and at least one of the at least one gas inlet. By returning the at least one first flow and/or the at least one second flow filtered with the filter system to the dryer, the filtering process can be repeated and thus carried out even more effectively. If, in addition, the temperature of the gas stream in the dryer is increased above room or ambient temperature by means of a heating device, the recirculated first flow and/or the recirculated filtered second flow preferably also have a temperature above room or ambient temperature, as a result of which the heating device is supported and the products can be dried in a particularly energy-efficient manner. For this purpose, the first fluid line and/or the filter fluid line may be thermally insulated. Alternatively, at least a portion of the heat of the first flow and/or of the filtered second flow may be provided to the dryer via a heat exchanger.

In order to be able to separate the particles from the gas even more precisely in the gas-particle separator and keep them in the second flow path, the fan can be a radial fan with a fan housing and an impeller arranged therein, and in particular a separator ring arranged around an axis of rotation of the impeller and projecting from an inner side of the fan housing can be provided in the fan housing. The separator ring supports the guidance of the particles in the second flow path after they have been sucked into the second flow path by means of the impeller, and helps to prevent the particles from undesirably falling back into the first flow path. The separator ring may be designed as a curved flat iron. For example, the separator ring may be arranged in a plane perpendicular to the axis of rotation of the impeller. As is known, a radial fan sucks a gas into the fan housing in the direction of the axis of rotation of the impeller, deflects the gas into a radial direction of the impeller as a result of the rotation of the impeller, and blows the gas out of the fan housing again in the radial direction.

The products can be dried particularly efficiently if the dryer is a continuous dryer, in particular a belt dryer. In a continuous dryer, the products are conveyed through the dryer. In one embodiment as a belt dryer, the continuous dryer particularly preferably comprises a circulating conveyor belt on which the products can rest. Continuous dryers may also have the advantage of a low construction height.

Furthermore, it is preferred that the dryer comprises a plurality of drying zones, in particular a plurality of drying chambers, and preferably comprises a controller which is designed for setting different process parameters in the drying zones, in particular different residence times of the products to be dried and/or different temperatures and/or different volumetric flows of the gas. The product to be dried can thus pass through a plurality of drying zones, in particular a plurality of drying chambers, expedient process parameters being set in each drying zone/drying chamber. The controller may be connected to an input device, such as a keyboard, and an output device, such as a screen, for inputting and/or controlling the process parameters. The at least one gas inlet may be connected to at least one drying zone or drying chamber, and the at least one gas outlet can also be connected to at least one drying zone or drying chamber. For example, each drying zone or drying chamber may be connected to its own gas outlet.

The dryer system can be designed to be particularly simple and environmentally friendly if the gas comprises air or is air.

With regard to the method, it is provided that:
with a fan of a gas-particle separator of at least one of the gas suction devices, the gas flow along the products is generated through the gas-particle separator;
the gas flow in the gas-particle separator is divided into a first flow, in particular main flow, and a second flow, in particular secondary flow, the first flow having a smaller mass flow of the particles than the second flow;
the first flow is released via a first output, in particular main output, of the gas suction device; and
the second flow is guided via a second output, in particular a secondary output, of the gas suction device into a filter system connected to the second output and is filtered in the filter system.

The method for drying products thus provides for the products to be introduced into a dryer. In particular, the products to be dried may be received by a receiving device, for example placed as uniformly as possible on a drying belt. The received products are exposed to a gas flow in the dryer, preferably also to a temperature above room temperature or above ambient temperature. The gas flow absorbs moisture from the products, causing them to dry. The gas brought into contact with the products and particles of the products entrained with the gas are conducted out of the dryer with at least one gas suction device. Before the suctioned-off gas may be released into the environment, at least some of the particles contained in the gas must be filtered out. Which particles must be filtered out is defined at least by legal requirements. In order not to have to filter the entire gas stream, the gas stream is divided. For this purpose, at least one of the gas suction devices comprises a gas-particle separator with a fan that generates the gas flow along the products and through the gas-particle separator. The gas-particle separator divides the gas flow in the gas-particle separator into a first flow, in particular a main flow, and a second flow, in particular a secondary flow. The resulting first flow has a smaller mass flow of the particles than the second flow. If the first flow is a main flow and the second flow is a secondary flow, the main flow has a larger volumetric flow of the gas and a smaller mass flow of the particles than the secondary flow. The generated first flow is discharged from the gas suction device via a first output, in particular the main output, of the gas suction device. The generated second flow, in particular secondary flow, on the other hand, is guided via a second output, in particular secondary output, of the gas suction device into a filter system connected to the second output and filtered in the filter system. Since the filter system only has to filter the second flow with a small volumetric flow of the gas compared to the total flow, the filter system can be dimensioned correspondingly small and operated in an energy-saving manner. With regard to the features of the method, reference is also made to the preceding description of the dryer system, insofar as this is helpful for understanding the method and insofar as features of the method can be derived from this description of the dryer system. Likewise, with regard to the features of the dryer system, reference is also made to the description of the method.

According to a preferred embodiment of the method, it is provided that the first flow and the second flow are guided into a tubular connecting body connected to a separator output of the gas-particle separator and comprising the first output and the second output. In this way, the first flow through the first output and the second flow through the second output can be directed out of the tubular connecting body of the gas suction device. For this purpose, the tubular connecting body is connected to a separator output of the gas-particle separator. The gas-particle separator or an existing fan therefore does not need to be modified to divert the second flow.

When the pressure of the second flow to a particle filter of the filter system is increased with a filter fan of the filter system, the particle filter may be dimensioned smaller and have a higher density. The filter fan therefore pushes or sucks the particle-laden gas through the particle filter.

If it proves advantageous to operate a plurality of smaller filter systems, it is advantageous if the second flows from all gas suction devices with gas-particle separators are guided into individual functionally separate filter systems and are filtered in the separate filter systems.

If, on the other hand, it proves advantageous to operate a comparatively larger filter system, it is preferred that the second flows of at least two gas suction devices with gas-particle separators, in particular of all gas suction devices with gas-particle separators, are guided into a common filter system and are filtered in the common filter system.

The invention is explained in more detail below on the basis of preferred, non-limiting exemplary embodiments with reference to the drawings.

### BRIEF DESCRIPTION OF THE FIGURES

In the drawings:

FIG. 1 shows a dryer system according to the invention with a dryer, a gas suction device and a filter system, in a schematic illustration;

FIG. 2A shows the gas suction device with a gas-particle separator, in an enlarged schematic illustration, in an elevation view opposite the direction of the gas flow into the gas-particle separator;

FIG. 2B shows the gas suction device of FIG. 2A in an elevation view perpendicular to the direction of gas flow into the gas-particle separator;

FIG. 2C shows a top view of the gas suction device of FIG. 2A;

FIG. 3 shows a schematic diagram in which each gas suction device with gas-particle separator is connected to its own filter system;

FIG. 4 shows a schematic diagram in which all gas suction devices with gas-particle separators are connected to a common filter system; and

FIG. 5 shows a flowchart of the method for drying products.

### DETAILED DESCRIPTION

It should be noted that the individual figures are not necessarily shown to scale. In addition, in individual figures, parts of the dryer system that can be seen in other figures may be omitted, provided that the omitted parts are not essential for the description of the individual figures.

For the sake of clarity, if the figure description refers to only one component from a possible group of components, such as a single gas inlet, a single gas outlet, a single gas suction device, a single gas-particle separator, a single filter system and/or a single first fluid line or filter fluid line, this is not necessarily to be understood as limiting the dryer system to only this one component. A person skilled in the art can easily understand the necessary changes in order to replace one component with a plurality of components, for example in order to replace a gas suction device with a plurality of gas suction devices or a filter system with a plurality of filter systems.

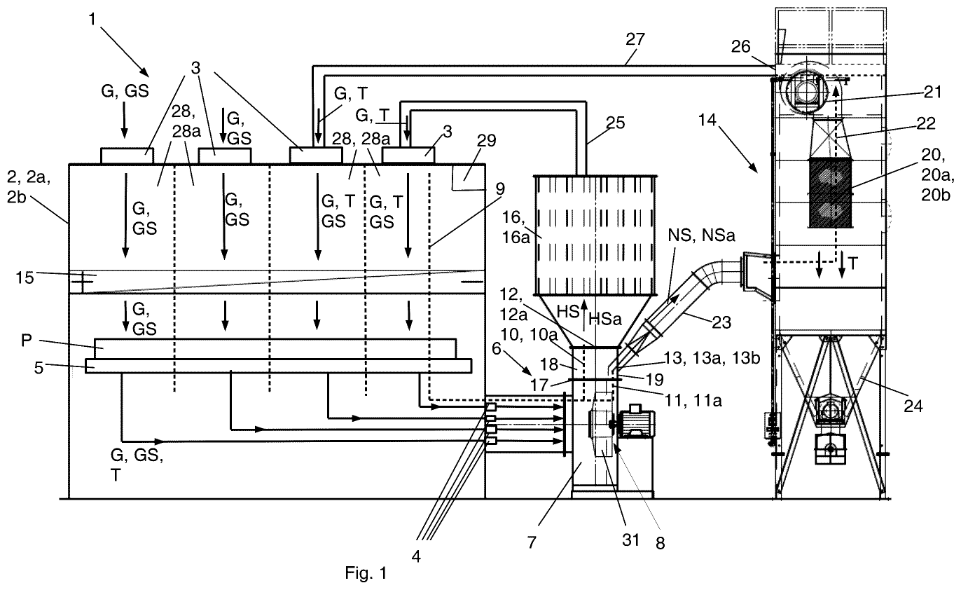

FIG. 1 schematically shows a dryer system 1, which comprises a dryer 2 for products P to be dried, at least one gas inlet 3 connected to the dryer 2, and at least one gas outlet 4 connected to the dryer 2. In the example according to FIG. 1, four gas inlets 3 and four gas outlets 4 are connected to the dryer 2. Gas G, in particular gas G which comprises air or is air, is introduced into the dryer 2 via the gas inlet 3. Gas G is let out from dryer 2 via gas outlet 4. The dryer 2 may be a continuous dryer 2a, in particular a belt dryer 2b. Arranged between the at least one gas inlet 3 and the at least one gas outlet 4 is a receiving device 5 designed to receive the products P to be dried. In the example shown, products P to be dried are already arranged on the receiving device 5. In operation, the gas G is guided over the products P, causing them to be dried. In the example according to FIG. 1, the dryer 2 also comprises a heating device 15, in particular between the at least one gas inlet 3 and the receiving device 5, in order to heat the gas G to be guided via the products P and thereby accelerate the drying. During the drying of the products P, the flowing gas G absorbs moisture from the products P and carries small particles, i.e. particles T, from the products P. The particles T are guided out of the dryer 2 together with the moisture-laden gas G via the at least one gas outlet 4. The gas flow GS in the dryer 2 is represented by arrows in FIG. 1. The dryer system 1 also comprises at least one gas suction device 6 which is connected to the at least one gas outlet 4 and is designed to extract gas G and particles T of the products P entrained with the gas G. In the example according to FIG. 1, a single gas suction device 6 is shown, which is connected to all gas outlets 4. The gas suction device 6, or generally at least one of the at least one gas suction device 6, comprises a gas-particle separator 7 with a fan 8 for generating the gas flow GS. It can clearly be seen in FIG. 1 that the fan 8 is arranged in a flow path 9 running from the gas inlet 3 via the gas outlet 4 and through the gas-particle separator 7 and is shown in dashed lines and symbolically in FIG. 1. In an operating state of the gas suction device 6, in particular when the fan 8 rotates, the gas-particle separator 7 is designed to separate the flow path 9 in the gas-particle separator 7 into a first flow path 10, which can be, in particular, a main flow path 10a, and a second flow path 11, which can be, in particular, a secondary flow path 11a, in such a way that a smaller mass flow of the particles T is provided in the first flow path 10 than in the second flow path 11 and, if appropriate, a larger volumetric flow of the gas G and a smaller mass flow of the particles T than in the secondary flow path 11a are provided in the main flow path 10a. For diverting the divided gas flow GS, the gas suction device 6 comprises a first output 12, which can be a main output 12a, into which first output 12 the first flow path 10 merges or into which main output 12a the main flow path 10a merges, and the gas suction device 6 comprises a second output 13, which can be a secondary output 13a, into which second output 13 the second flow path 11 merges or into which secondary output 13a the secondary flow path 11a merges. The second output 13 is connected to a filter system 14, which is designed to separate the particles T in the second flow path 11 from the gas G in the second flow path 11. The first flow HS flowing in the first flow path 10 can be discharged into the environment or returned to the dryer 2 via an exhaust air opening 16, in particular a muffler 16a, of the gas suction device 6.

The example according to FIG. 1 further shows that the first output 12 and the second output 13 are provided in a tubular connecting body 18 connected to a separator output 17 of the gas-particle separator 7. In the illustration according to FIG. 1, the second output 13 is a through-opening 13b in a circumferential lateral surface 19 of the connecting body 18.

The filter system 14 shown in FIG. 1 comprises a particle filter 20 and a filter fan 21 assigned to the particle filter 20, wherein in particular the particle filter 20 and the filter fan 21 are arranged in a common, dashed and symbolically illustrated filter flow path 22. The particle filter 20 is designed to filter the particles T from the second flow NS flowing in the second flow path 11 and introduced into the filter system 14. In the example according to FIG. 1, the second output 13 is connected to the filter system 14 via a connecting fluid line 23. The filter fan 21 conveys the second flow NS to be filtered through the particle filter 20. In the example according to FIG. 1, particles T separated during the filtering process fall into a collecting tank 24 of the filter system 14 or below the filter system 14. The particle filter 20 may preferably be a bag filter 20a or a cartridge filter 20b.

A first fluid line 25 for returning gas G and particles T from the first flow path 10 into the gas inlet 3 is preferably provided between the first output 12 of at least one of the gas suction devices 6 and at least one of the at least one gas inlet 3. In the example according to FIG. 1, exactly one first fluid line 25 is provided between the first output 12 of the gas suction device 6 and a gas inlet 3. Additionally or alternatively, a filter fluid line 27 for returning gas G and any remaining particles T from the second flow path 11 into the gas inlet 3 may be provided between a filter output 26 of at least one filter system 14 and at least one of the at least one gas inlet 3. In the example according to FIG. 1, exactly one filter fluid line 27 is provided between a filter output 26 and exactly one gas inlet 3.

In the example according to FIG. 1, the dryer 2 is shown with a plurality of drying zones 28, in particular a plurality of drying chambers 28a. The boundaries of the drying zones 28 or drying chambers 28a are indicated by dashed lines. Furthermore, a controller 29 of the dryer 2 is shown, which is designed to set different process parameters in the drying zones 28, in particular different residence times of the products P to be dried in the dryer 2 and/or different temperatures in the dryer 2 and/or different volumetric flows of the gas G in the dryer 2.

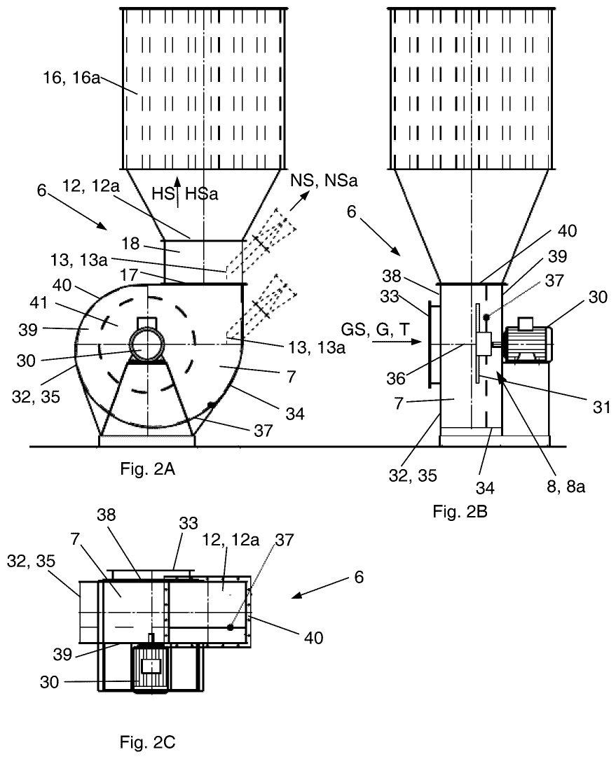

FIG. 2A shows the gas suction device 6 with the gas-particle separator 7, in an enlarged schematic illustration, in a rear view, i.e. opposite the direction of the gas flow GS into the gas-particle separator 7. FIG. 2B shows the gas suction device 6 in a side view, perpendicular to the direction of the gas flow GS into the gas-particle separator 7. The gas suction device 6 comprises, clearly visible in addition to the gas-particle separator 7, a tubular connecting body 18, which is connected to a separator output 17 of the gas-particle separator 7, in particular is placed on it, and comprises the first output 12 and the second output 13. FIG. 2A also shows an alternative construction in which the second output 13 is provided in the gas-particle separator 7 itself. The differently arranged second outputs 13 are illustrated with dashed lines. In the example shown, the gas suction device 6 also comprises an exhaust air opening 16, in particular a muffler 16a, which may, however, be omitted if the first flow HS is returned to a gas inlet 3. The gas-particle separator 7 comprises an impeller 31, driven via a motor 30, of a fan 8, the impeller 31 being received in a housing 32 of the gas-particle separator 7, see in particular FIG. 2B. In operation, the rotating impeller 31 sucks the gas flow GS through a separator input 33 of the gas-particle separator 7 into the housing 32 and causes the gas flow GS and thus also the particles T to rotate. The particles T are deflected by the centrifugal force acting thereon onto an inner side 34 of the housing 32 and guided along the latter as far as the second output 13 and emerge from the gas suction device 6 through the second output 13 in the inner side 34 of the housing 32 or in the lateral surface 19 of the connecting body 18. The gas-particle separator 7 thus acts as a particle concentrator and centrifugal separator.

In FIGS. 2A, 2B and 2C, the fan 8 is illustrated as a radial fan 8a with a fan housing 35 and an impeller 31 arranged therein. In the example shown, the fan housing 35 is the housing 32 of the gas-particle separator 7. In the example shown, a separator ring 37, which is arranged around an axis of rotation 36 of the impeller 31 and protrudes from the inner side 34 of the fan housing 35, is also provided in the fan housing 35. The gas-particle separator 7 preferably comprises a front wall 38 with the separator input 33, a rear wall 39 opposite the front wall 38, and a circumferential, preferably at least partially round side wall 40, which connects the front wall 38 to the rear wall 39. In the example shown, the separator ring 37 projects inward from the inner side 34 of the circumferential side wall 40. During operation of the gas-particle separator 7, the particles T sucked into the housing 32 are sucked through an annular opening 41 surrounded by the separator ring 37, pressed against the inner side 34 of the housing 32, and held in the space between the separator ring 37, the side wall 40, and the rear wall 39 until the moving particles T emerge from the second output 13. The first flow HS, on the other hand, emerges from the first output 12.

In FIG. 2C, the separator ring 37 is partially visible through the first output 12.

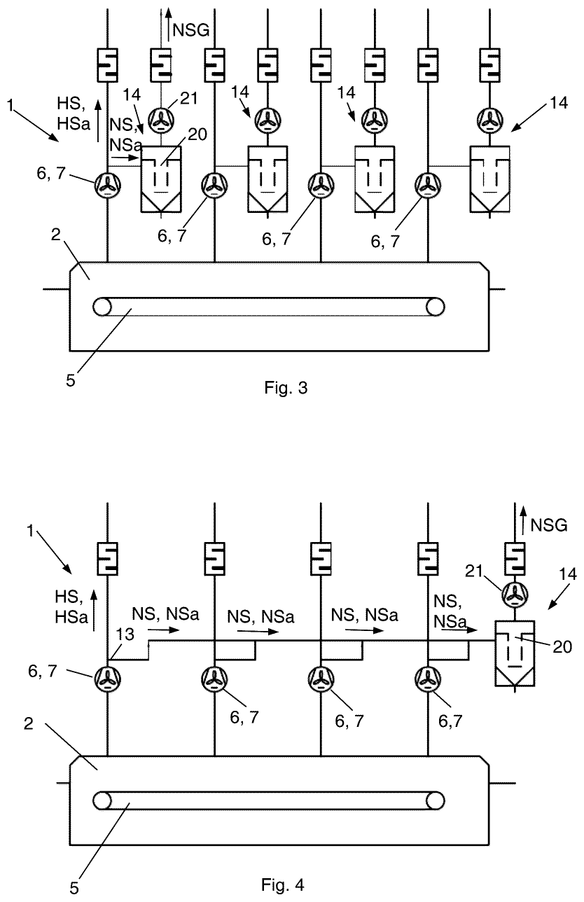

FIG. 3 shows a schematic diagram of a dryer system 1, in which each gas suction device 6 with gas-particle separator 7 is connected to its own filter system 14. At least one of the first flows HS at the output of the gas-particle separators 7 and/or at least one of the filtered second flows NSG at the output of the filter systems 14 can be returned to the dryer 2 (not shown in FIG. 3).

In contrast, FIG. 4 shows a schematic diagram of a dryer system 1, in which the second outputs 13 of at least two gas suction devices 6 with gas-particle separator 7, in the example shown of all gas suction devices 6 with gas-particle separator 7, are connected to a common filter system 14. In this case, too, at least one of the first flows HS at the output of the gas-particle separators 7 and/or the filtered second flow NSG at the output of the filter system 14 can be returned to the dryer 2 (not shown in FIG. 4).

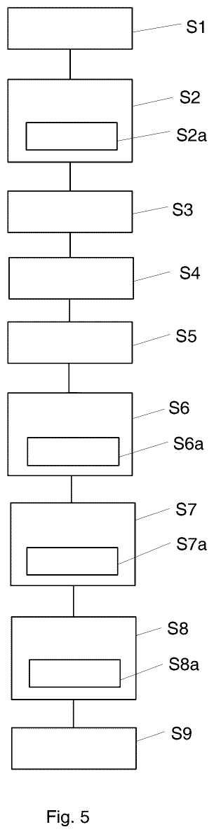

FIG. 5 shows an exemplary flowchart of the method for drying products P.

In a step S1, the products P to be dried are introduced into a dryer 2.

In a step S2, the products P introduced into the dryer 2 are subjected to a gas flow GS in the dryer 2.

In a sub-step S2a, the gas flow GS along the products P is generated by a fan 8 of a gas-particle separator 7 of at least one of the gas suction devices 6.

In a step S3, the gas G brought into contact with the products P and particles T of the products P, the particles T being entrained with the gas G, are conducted out of the dryer 2 by the at least one gas suction device 6.

In a step S4, the gas flow GS through the gas-particle separator 7 is generated by the fan 8 of the gas-particle separator 7 of the at least one gas suction device 6.

In a step S5, the gas flow GS in the gas-particle separator 7 is divided into a first flow HS, in particular a main flow HSa, and a second flow NS, in particular a secondary flow NSa, in such a way that the first flow HS has a smaller mass flow of the particles T than the second flow NS or, if appropriate, the main flow HSa has a larger volumetric flow of the gas G and a smaller mass flow of the particles T than the secondary flow NSa.

In a step S6, the first flow HS/main flow HSa is released via a first output 12/main output 12a of the gas suction device 6.

In a sub-step S6a, the first flow HS/main flow HSa is guided into a tubular connecting body 18 connected to a separator output 17 of the gas-particle separator 7 and comprising the first output 12/main output 12a.

In a step S7, the second flow NS/secondary flow NSa is guided via a second output 13/secondary output 13a of the gas suction device 6 into a filter system 14 connected to the second output 13/secondary output 13a.

In a sub-step S7a, the second flow NS/secondary flow NSa is guided into the tubular connecting body 18 connected to the separator output 17 of the gas-particle separator 7 and comprising the second output 13/secondary output 13a.

In a step S8, the second flow NS/secondary flow NSa guided into the filter system 14 is filtered in the filter system 14.

In a sub-step S8a, the pressure of the second flow NS/secondary flow NSa is increased to a particle filter 20 of the filter system 14 with a filter fan 21 of the filter system 14.

In a step S9, the second flow NS/secondary flow NSa is guided from at least one further gas suction device 6 with gas-particle separator 7, in particular from all gas suction devices 6 with gas-particle separator 7, into a common filter system 14 and filtered in the common filter system 14.

1. A dryer system comprising:
a dryer for products to be dried,
at least one gas inlet connected to the dryer,
at least one gas outlet connected to the dryer,
wherein the dryer comprises a receiving device between the at least one gas inlet and the at least one gas outlet, the receiving device being designed to receive the products to be dried, and
at least one gas suction device connected to the at least one gas outlet for suctioning-off gas and particles of the products, the particles being entrained with the gas,
wherein at least one of the at least one gas suction device comprises a gas-particle separator with a fan for generating a gas flow,
wherein the fan is arranged in a flow path running from the gas inlet via the gas outlet and through the gas-particle separator,
wherein, in an operating state of the gas suction device, the flow path in the gas-particle separator comprises a first flow path,
wherein the gas suction device comprises a first output into which the first flow path merges, and a second output into which the second flow path merges, and
wherein the second output is connected to a filter system.

2. The dryer system according to claim 1, wherein the first output and the second output are provided in a tubular connecting body connected to a separator output of the gas-particle separator.

3. The dryer system according to claim 2, wherein the second output is a through-opening in a circumferential lateral surface of the connecting body.

4. The dryer system according to claim 1, wherein the filter system comprises a particle filter and a filter fan assigned to the particle filter

5. The dryer system according to claim 1, wherein the second outputs of at least two gas suction devices with gas-particle separators, are connected to a common filter system.

6. The dryer system according to claim 5, wherein the particle filter is a bag filter or a cartridge filter

7. The dryer system according to claim 1, wherein a first fluid line for returning gas and particles from the first flow path into the gas inlet is provided between the first output of at least one of the gas suction devices and at least one of the at least one gas inlet, and/or a filter fluid line for returning gas and any remaining particles from the second flow path into the gas inlet is provided between a filter output of the filter system and at least one of the at least one gas inlet.

8. The dryer system according to claim 1, wherein the fan is a radial fan having a fan housing and an impeller arranged therein.

9. The dryer system according to claim 1, wherein the dryer is a continuous dryer.

10. The dryer system according to claim 1, wherein the dryer comprises a plurality of drying zones.

11. The dryer system according to claim 1, wherein the gas comprises air or is air.

12. A method for drying products comprising the steps of:
introducing the products into a dryer;
applying a gas flow in the dryer to the products;
discharging the gas brought into contact with the products and particles of the products, the particles being entrained with the gas, out of the dryer with at least one gas suction device;
generating a gas flow with a fan of a gas-particle separator of at least one of the at least one gas suction devices;
splitting the gas flow in the gas-particle separator into a first flow and a second flow, the first flow having a smaller mass flow of the particles than the second flow;
releasing the first flow via a first output of the gas suction device;
guiding the second flow via a second output of the gas suction device into a filter system connected to the second output; and
filtering the second flow in the filter system.

13. The method according to claim 12, wherein the first flow and the second flow are guided into a tubular connecting body connected to a separator output of the gas-particle separator and comprising the first output and the second output.

14. The method according to claim 12, wherein the pressure of the second flow on a particle filter of the filter system is increased with a filter fan of the filter system.

15. The method according to claim 12, wherein the second flows of at least two gas suction devices with gas-particle separators are guided into a common filter system and are filtered in the common filter system.

16. The dryer system according to claim 1, wherein the first flow path is a main flow path and the second flow path is a secondary flow path, such that a smaller mass flow of the particles is provided in the first flow path than in the second flow path; and wherein the first output is a main output and the second output is a secondary output.

17. The dryer system according to claim 4, wherein the particle filter and the filter fan are arranged in a common filter flow path.

18. The dryer system according to claim 5, wherein the at least two gas suction devices with gas-particle separators is all gas suction devices with gas-particle separators.

19. The dryer system according to claim 8, wherein a separator ring is provided in the fan housing, the separator ring being arranged around an axis of rotation of the impeller and protruding from an inner side of the fan housing.

20. The dryer system according to claim 9, wherein the dryer is a belt dryer.
